(19) United States
(12) Patent Application Publication
(10) Pub. No.: US 2002/0128875 A1
(43) Pub. Date: Sep. 12, 2002

(54) System and method for providing customer support

(76) Inventor: Travis Parry, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/800,854

(22) Filed: Mar. 7, 2001

(51) Int. Cl. G06F 17/60; H04N 7/14

(52) U.S. Cl. 705/4; 348/14.01; 379/265.09

(57) ABSTRACT

The present disclosure relates to a system and method for providing customer support to an electrical device user. The method comprises the steps of establishing a communications link between a customer support representative and the user with a customer support unit associated with the electrical device, and transmitting communications of the customer support representative to the user while the user is at the electrical device via the customer support unit. In a preferred arrangement, audio and video data are exchanged between the customer support representative and the user through the provision of a customer support unit that electrically connects with the electrical device (e.g., a peripheral device).

### FIELD OF THE INVENTION

The present disclosure relates to a system and method for providing customer support. More particularly, the disclosure relates to a system and method for providing customer support to a peripheral device user at the peripheral device.

### BACKGROUND OF THE INVENTION

When a user is having difficulty with an electrical device such as a peripheral device, the user can consult the vendor's user manual or, in business office contexts, consult a system administrator familiar with the device. In situations in which the user cannot resolve the problem with reference to the user manual or a system administrator, the user can call a customer support line, normally from a remotely located telephone, which is maintained by the vendor to provide support from a customer support representative.

Before such a call can be placed, the user must first locate the customer support telephone number, identify any authorization information that the customer support representative may require (e.g., serial number, model number, etc.), call the number, respond to all prompts put forth by an automated routing system, and wait in a queue until an appropriate customer support representative becomes available. Once a representative is available, the user can communicate the problem to the representative, receive advice as to how to resolve the problem, and then apply the customer support representative's recommendations to the electrical device.

While this procedure can be effective, it can be frustrating for the user in situations in which the course of action recommended by the customer support representative does not resolve the problem. In such a case, the user normally must return to his or her telephone and place another call to the customer support line. Once this call is placed, the user must again go through all system prompts and wait in the queue. In addition, once the user reaches the customer support representative, it often is a different representative from that to which the user had previously spoken. Therefore, the user must often re-describe the problem to the representative, as well as the failed attempt to resolve the problem. At this point, the user can receive further instructions as to how to fix the problem and again apply them to the malfunctioning device. If this new course of action does not work, the user can again call the customer service line and repeat the process.

From the above, it can be appreciated that it would be desirable to have a system and method in which a device user can receive support from a customer support representative at the malfunctioning device such that the user can attempt to resolve the problem while still maintaining communications with the representative in case the proposed solution does not work.

### SUMMARY OF THE INVENTION

The present disclosure relates to a system and method for providing customer support to an electrical device user. The method comprises the steps of establishing a communications link between a customer support representative and the user with a customer support unit associated with the electrical device, and transmitting communications of the customer support representative to the user while the user is at the electrical device via the customer support unit.

The system comprises means for transmitting customer support representative communications across a network, and means for presenting the customer support representative communications to a user at the electrical device. In a preferred arrangement, the system comprises a customer support unit that is adapted to electrically connect to the electrical device, the customer support unit comprising a speaker and a display that are adapted to present audio and video data of a customer support representative to the user, and network interface devices that are adapted to transmit and receive communications across a network.

The features and advantages of the invention will become apparent upon reading the following specification, when taken in conjunction with the accompanying drawings.

### BRIEF DESCRIPTION OF THE DRAWINGS

The invention can be better understood with reference to the following drawings. The components in the drawings are not necessarily to scale, emphasis instead being placed upon clearly illustrating the principles of the present invention.

FIG. 1 is a schematic view that illustrates a system for providing customer support.

FIG. 2 is a schematic view that illustrates an example architecture of an electrical device shown in FIG. 1.

FIG. 3 is a flow diagram that illustrates the operation of a web server module shown in FIG. 2.

FIG. 4 is a schematic view that illustrates an example architecture of a computing device shown in FIG. 1.

FIG. 5 is a flow diagram that illustrates the operation of a control module shown in FIG. 4.

FIGS. 6A-6C provide views of a flow diagram that illustrates a method for receiving customer support with the system shown in FIG. 1.

FIG. 7 is a perspective view of an electrical device that can be used in the system shown in FIG. 1.

### DETAILED DESCRIPTION

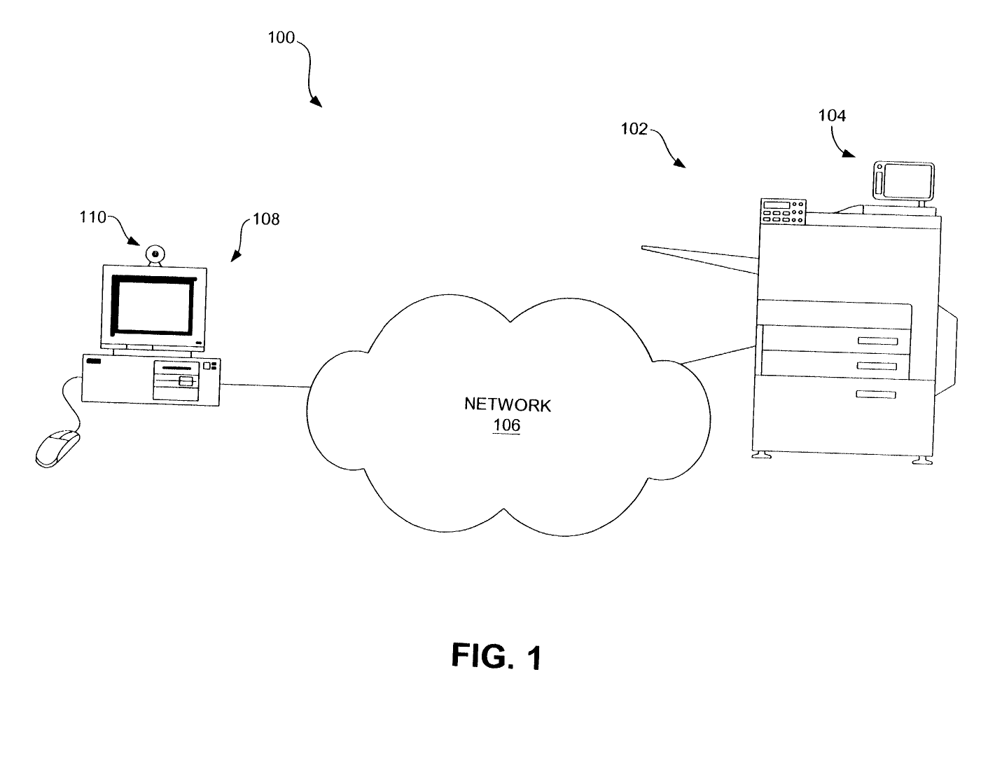

Referring now in more detail to the drawings, in which like numerals indicate corresponding parts throughout the several views, FIG. 1 illustrates a system 100 for providing customer support. The system 100 can comprise an electrical device 102 that, by way of example, comprises a peripheral device. When the electrical device 102 is a peripheral device, it can be substantially any peripheral device with which a user may require support. For example, the peripheral device can comprise a printer, photocopier, facsimile machine, scanner, digital sender, multi-function peripheral, etc. As indicated in FIG. 1, the electrical device 102 can include a customer support unit 104, the purpose for which is described below.

The electrical device 102 is connected to a network 106 that, by way of example, comprises the Internet. Through such a connection, the electrical device 102 can post data to the Internet and receive data (as well as commands) from a remote computing device 108 of a customer support representative. By way of example, the computing device 108 can comprise a desktop computer that includes a web camera 110. Although shown and described as comprising a desktop computer, it will be understood from the present disclosure that the computing device can comprise a dedicated customer support device specifically adapted to provide customer support to device users.

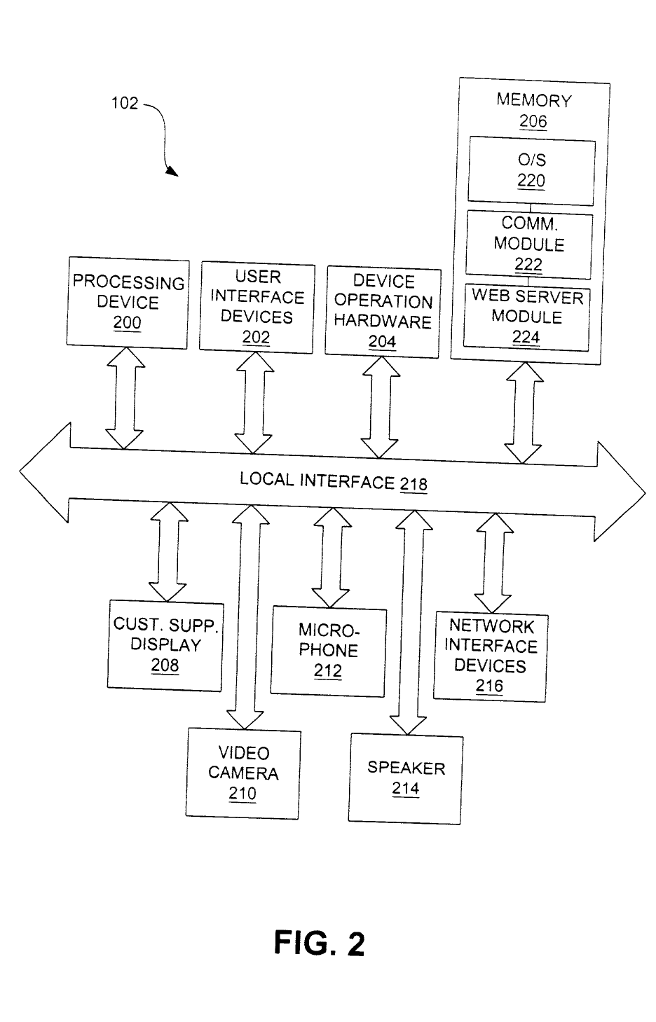

FIG. 2 is a schematic view illustrating an example architecture for the electrical device 102 shown in FIG. 1. As indicated in FIG. 2, the electrical device 102 comprises a processing device 200, user interface devices 202, device operation hardware 204, memory 206, a customer support display 208, a video camera 210, a microphone 212, a speaker 214, network interface devices 216, and a local interface 218 to which each of the other components electrically connects. The processing device 200 is adapted to execute commands stored in memory 206. The processing device 206 can comprise a general-purpose processor, a microprocessor, one or more application-specific integrated circuits (ASICs), a plurality of suitably configured digital logic gates, and other well known electrical configurations comprised of discrete elements both individually and in various combinations to coordinate the overall operation of the peripheral device 102. The user interface devices 202 typically comprise interface tools with which the user, i.e., customer, can communicate commands to the electrical device 102. By way of example, the devices 202 can comprise various function keys with which the settings of the device 102 can be changed, and a display screen with which information (e.g., device status and settings) can be communicated to the customer. The device operation hardware 404 comprises the various mechanisms that are used to perform the various functionalities of the electrical device 102. For instance, where the device 102 is a photocopier, this hardware can include a document feeder, scanner, etc. used by the device to produce photocopies of an original document.

The customer support display 208 normally comprises a display screen with which the customer can view video of a customer support representative. By way of example, this display 208 can comprise a touch-sensitive display with which commands can be entered by the customer. The video camera 210 normally comprises a digital camera (such as web camera) that is adapted to capture video images of the customer that can be transmitted to the customer support representative. The network interface devices 216 are adapted to facilitate communications across the network 106 (e.g., Internet) and therefore can comprise a modem or other data transmitting/receiving device. In particular, the network interface devices 216 are adapted to transmit audio and video of the customer collected via the microphone 212 and video camera 210 to the customer support representative, and to receive audio and video from a customer support representative for presentation to the user.

The memory 206 includes an operating system 220, a communications module 222, and a web server module 224. The operating system 220 contains the various commands used to control the general operation of the electrical device 102. The communications module 222 comprises software and/or firmware that is adapted to, in conjunction with the network interface devices 216, facilitate communications over the network 106 (e.g., Internet) and, more particularly, to transmit and receive audio and video data. The web server module 224 comprises software and/or firmware that is adapted to collect and format information about the status and settings of the electrical device 102, such that this information, with the customer's permission, can be presented to the customer support representative.

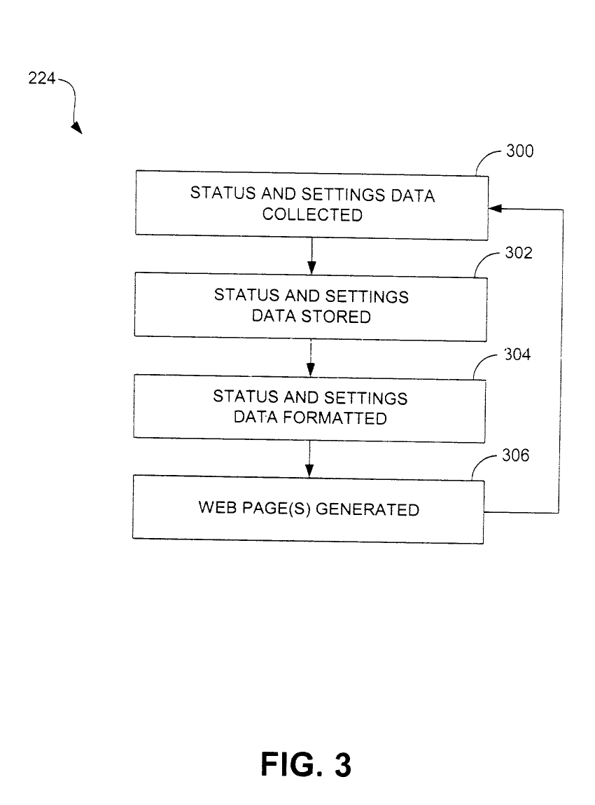

FIG. 3 is a flow diagram that illustrates the operation of the web server module 224. With reference to block 300, the web server module 224 collects information as to the status and settings of the electrical device 102. For instance, the module 224 can collect information as to the configuration of the electrical device 102, all device settings that have been selected, and any error messages (e.g., from an error log maintained by the device 102) that reflect any malfunctions the device has experienced. Once this information is collected, it is stored by the module 224, as indicated in block 302. The stored information can be formatted, as indicated in block 304, for insertion into one or more web pages generated by the web server module 224. By way of example, the web pages can comprise standardized web page templates that include data fields that the web server module 224 populates with the collected device information. After the information is formatted, the web server module 224 generates the one or more web pages that identify the current status and settings of the electrical device 102, as indicated in block 306. In that the status and settings of the device 102 can change, flow returns to block 300 from block 306 such that the web pages are continually updated by the web server module 224. This updating can occur upon detection of changes to the status or settings of the device 102 and/or according to a predetermined time schedule. As is discussed below, the web pages can be made available to a customer support representative so as to share information as to the status and settings of the electrical device 102 with the representative. In addition, the web pages can, optionally, be displayed to the customer with the customer service display 208.

It is to be noted that although the electrical device 102 has been described and shown as integrating the customer support hardware, software, and/or firmware described above, it will be appreciated that this hardware, software, and/or firmware can be embodied within a device (e.g., customer support unit 104) that is separate and independent from, but applied to, the electrical device. In such a case, however, the electrical connections indicated in FIG. 2 are still applicable and the functionality described herein is the same.

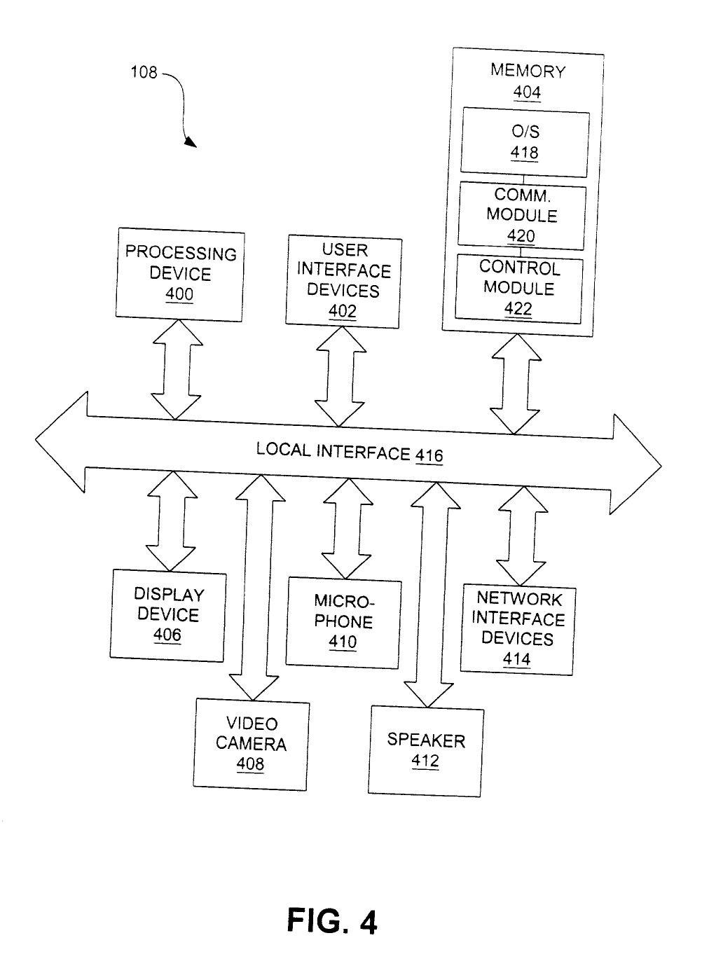

FIG. 4 is a schematic view illustrating an example architecture for the computing device 108 shown in FIG. 1. As indicated in FIG. 4, the computing device 108 comprises a processing device 400, user interface devices 402, memory 404, a display device 406, a video camera 408, a microphone 410, a speaker 412, network interface devices 414, and a local interface 416 to which each of the other components electrically connects. The processing device 400 is adapted to execute commands stored in memory 404 and typically comprises one or more central processing units (CPUs). The user interface devices 402 typically comprise interface tools with which the user, in this case a customer support representative, can communicate commands to the computing device 108. By way of example, the interface devices 402 can comprise a keyboard and mouse.

The display device 406 normally comprises a monitor with which the customer support representative can visually interface with the computing device 108. As is described below, this display device 406 can be used to present to the representative video images of a customer that is having a problem with an electrical device 102. The video camera 408 normally comprises a digital camera (such as web camera 110 shown in FIG. 1) that is adapted to capture video images of the customer support representative so that these images can be transmitted to the customer. Typically, the microphone 410 and speaker 412 form part of a headset the customer service provider wears, although it is to be understood that these components could be separate from such a headset and furthermore, separate from each other. The network interface devices 414 are adapted to facilitate communications across the network 106 (e.g., Internet) and therefore can comprise a modem or other data transmitting/receiving device.

As identified in FIG. 4, memory 404 comprises an operating system 418, a communications module 420, and a control module 416. The operating system 418 contains the various commands used to control the general operation of the computing device 108. The communications module 420 comprises software and/or firmware that is adapted to facilitate communications over the network 106 (e.g., Internet) and, more particularly, to transmit and receive video and audio across the network such that audio and video can be exchanged between the customer support representative and the customer. As is described in greater detail below, the control module 422 comprises software and/or firmware that is adapted to permit the customer support representative to determine the settings and status of the electrical device 102. In addition, the control module 422 permits the customer support representative to, when authorized, exercise control over the electrical device 102 such that the representative can change settings of the electrical device in an effort to correct a problem the customer is experiencing.

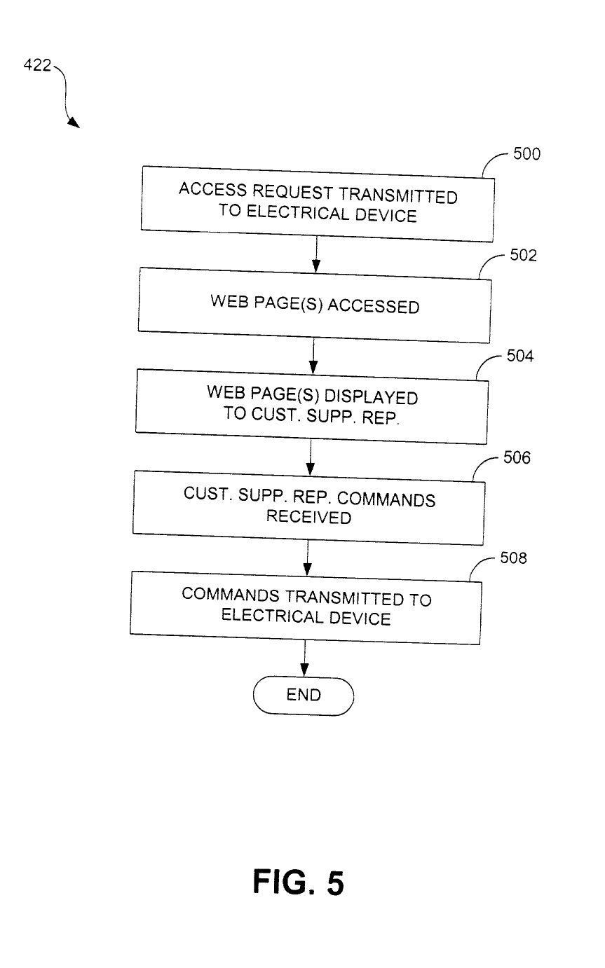

FIG. 5 is a flow diagram that illustrates the operation of the control module 422. With reference to block 500, the control module 422 transmits a request to access the web pages generated by the web server module 224 of the electrical device 102. As described above, this transmission is achieved through cooperation between the communications module 420 and network interface devices 414. Assuming the customer support representative has authorization to access the web pages, the web pages can be accessed by the control module 422, as indicated in block 502. Once accessed, the web pages can be displayed to the customer support representative, e.g., with display device 406 as indicated in block 504. The customer support representative can then review this information to gain insight as to the problem the customer is experiencing. If the customer support representative determines one or more sources of the problem, the representative can, with the customer's permission, make adjustments to the electrical device's settings via the control module 222, for instance by manipulation of a virtual control panel. In such a situation, the control module 422 receives commands of the customer support representative, as indicated in block 506, to change the settings of the electrical device 102. These commands are then transmitted to the electrical device 102, as indicated in block 508. As is described below, these commands are received by the electrical device 102 and the settings of the device changed as if they were directly input by the customer.

Various software and/or firmware modules have been described herein. It is to be understood that these modules can be stored and transported on any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device.

The computer readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CDROM). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

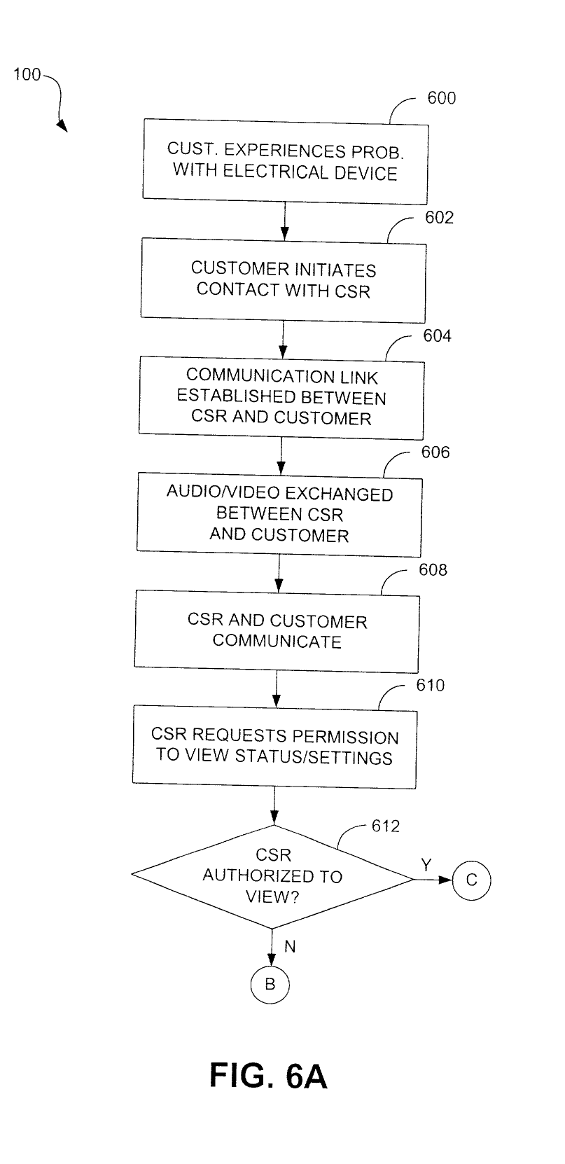

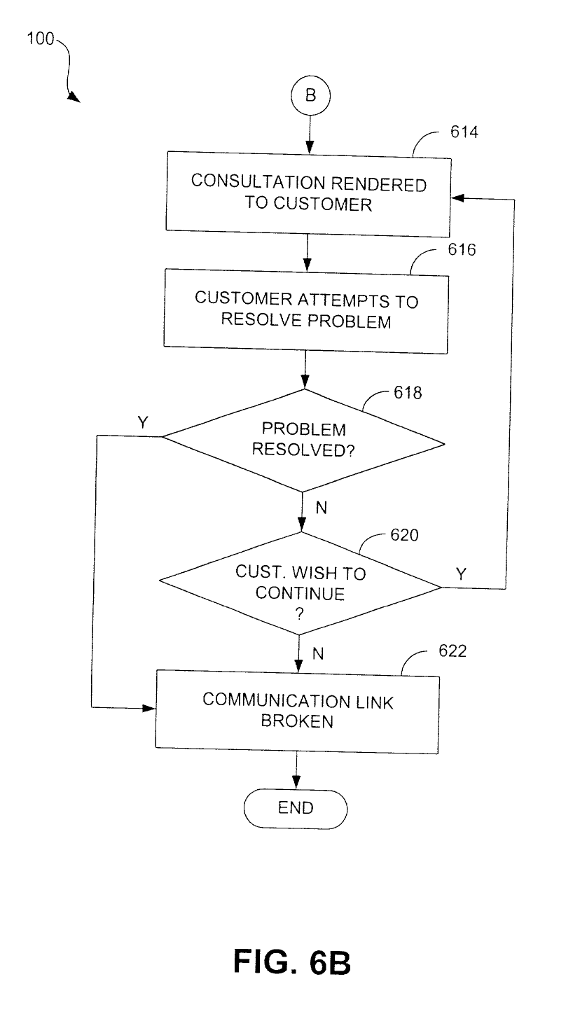

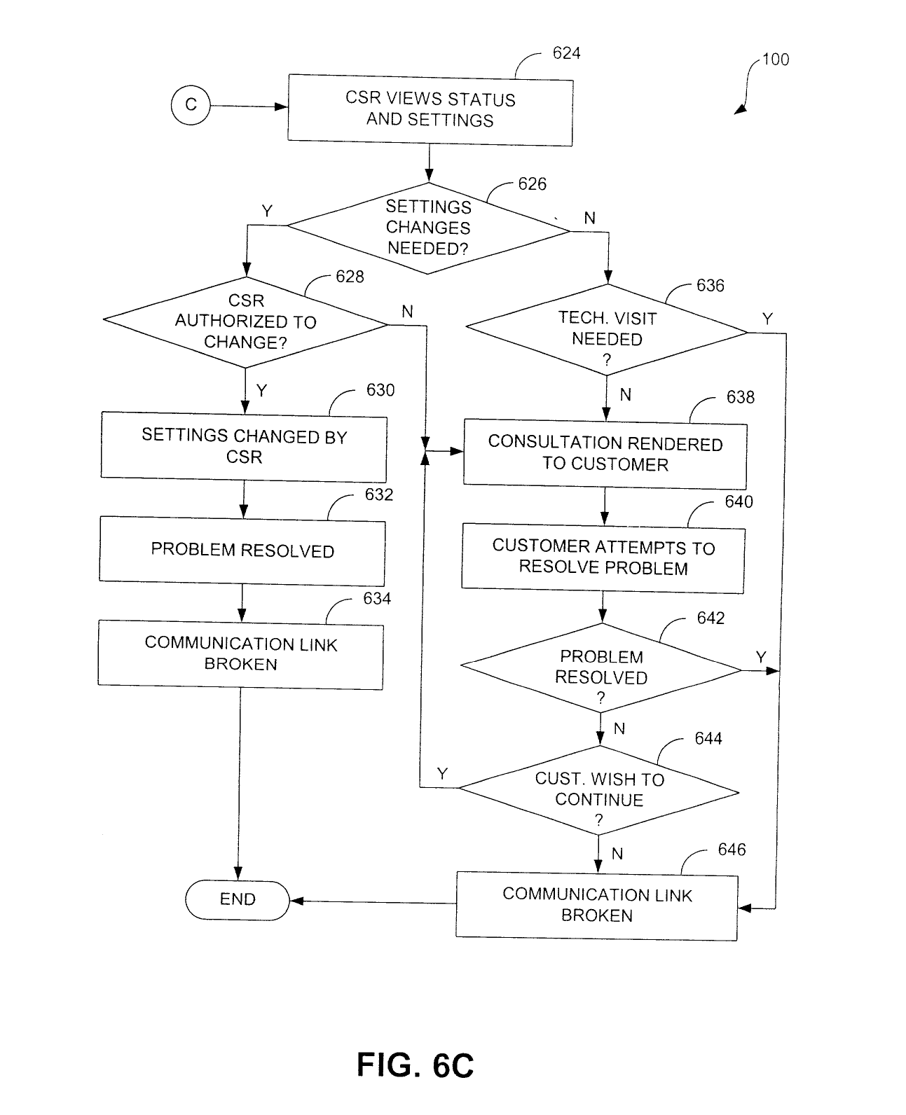

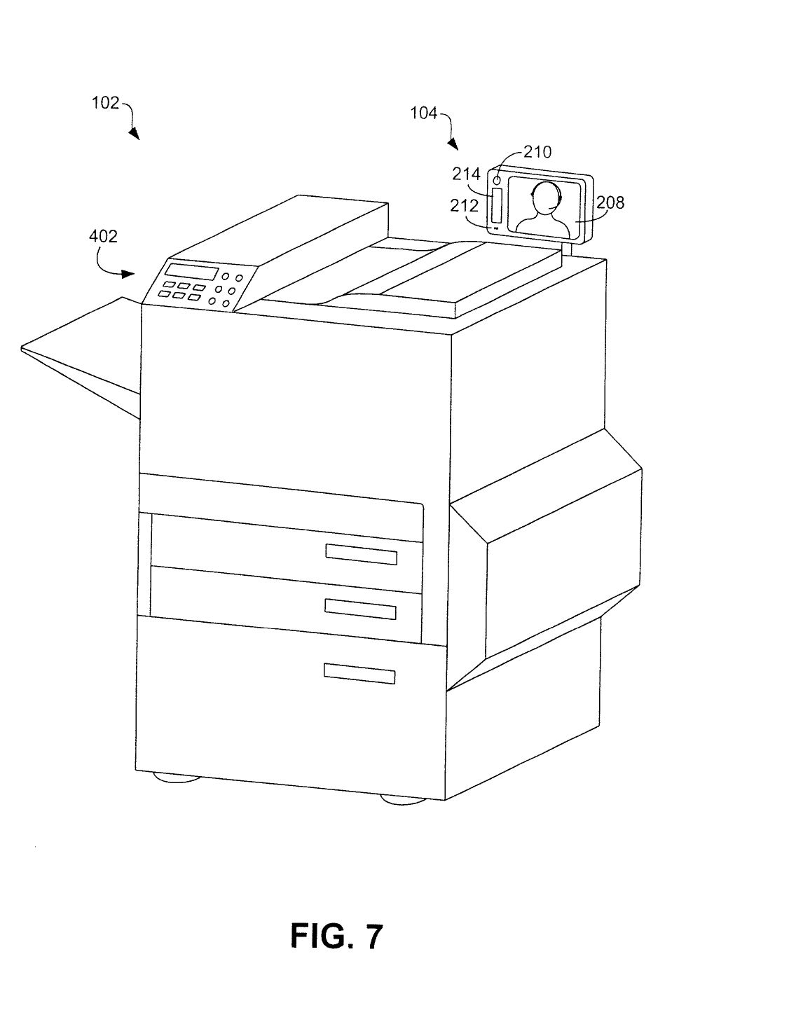

Operation of the system 100 will be discussed with reference to FIGS. 6A-6C and 7. More particularly, the following discussion describes a method for providing customer support to a customer with the system 100 shown in FIG. 1. With reference to block 600 of FIG. 6A, a customer can experience a problem with an electrical device 102 that he or she cannot resolve. The customer can then initiate contact with a customer support representative (CSR), as indicated in block 602. This normally entails the customer selecting a call button of the user interface devices 202. By way of example, such a call button can comprise a “soft” key presented to the user via the customer support display 208. With reference to FIG. 7, this display 208 can be integrated into the customer support unit 104. By selecting such a button or key, a service request is transmitted across the network 106 with the network interface devices 216 and routed to a customer support representative. A communication link is then established between the representative and the customer, as indicated in block 604.

At this point, audio and video data of the customer support representative are provided to the customer and vice versa, as indicated in block 606, as in a common video conferencing context. In particular, with reference to FIG. 7, video of the customer support representative can be provided in the customer support display 208 and audio of the representative can be provided with the speaker 214. As mentioned above, this audio and video data can be collected by the representative's computing device 108 with the microphone 410 and video camera 408, respectively. In similar manner, audio and video of the user can be collected by the microphone 212 and video camera 210 both of which, for example, being integrated into the customer support unit 104. Through this exchange of audio and video, the customer support representative and user can communicate with each other, as indicated in block 608. More specifically, the representative and the user can communicate with each other while the user is still positioned at the electrical device 102. Accordingly, the user can directly apply the recommendations of the representative without terminating communications with the representative. In addition, through the provision of video, the customer support representative and user can communicate with each other visually such that information can be conveyed between them more effectively than with audio alone.

As identified above, the system 100 is configured such that the customer support representative can view the status and settings of the electrical device 102 to diagnose and potentially correct the problem being experienced. Normally, as a security precaution, the customer support representative first needs authorization from the customer to obtain this access. Accordingly, the customer support representative can first request permission from the customer to access the status and settings information, as indicated in block 610. The customer can then determine whether he or she would like to provide this authorization, as indicated in decision element 612. By way of example, the user can authorize the representative to obtain this access by selecting an authorization grant button (not shown) that is presented as a soft key to the customer via the customer support display 208.

If the user either chooses not to extend this access, or where the electrical device 102 is configured such that this access cannot be extended (e.g., as a security precaution), flow continues to block 614 of FIG. 6B at which the customer support representative consults the customer as to how to overcome the problem being experienced. Such consultation normally comprises oral instructions given to the user as in the typical customer support call setting. In addition, however, the representative can further show the customer how to fix the device 102 in applicable situations due to the transmission of video data. Once having received the instructions, the customer can attempt to resolve the problem, as indicated in block 616. The customer can then attempt to fix the device 102 without terminating communications with the representative. Accordingly, the customer need not travel back and forth between a telephone and the electrical device 102 to apply the representative's recommendations.

As indicated in decision element 618, if the customer's actions resolve the problem, flow continues to block 622 at which the communication link with the customer support representative is broken and flow is terminated. If, on the other hand, the problem is not resolved, flow continues to decision element 620 where, based upon the representative's advice, the customer can determine whether to continue to receive instructions from the representative and try other courses of action. If so, flow returns to block 614. If not, for instance in a situation where the problem requires a visit from a technician, flow continues to block 622 where the communication link is broken and flow is terminated.

With reference back to decision element 612 in FIG. 6A, if the customer support representative is given the authorization to view the device status and settings, flow continues to block 624 in FIG. 6C at in which the representative views the status and settings. As described above, this information can be presented to the representative with one or more web pages generated and posted by the web server module 224 of the electrical device 102. By reviewing these pages, the customer support representative can determine the configuration of the device 102, receive diagnostic information about the device, as well as view the settings selected by the user for the device.

As indicated in decision element 626, if a mere configuration and/or settings change is needed, flow continues to decision element 628 where the customer can determine whether to give the representative authorization to change the settings. If the customer decides not to (or cannot) provide this authorization, the flow continues to block 638 and the customer support representative consults the customer as to how to overcome the problem in similar manner to that described above. Once having received the instructions, the customer can attempt to resolve the problem as indicated in block 640, and if the customer's actions resolve the problem (element 642), flow continues to block 646 at which the communication link is broken and flow terminated. If, on the other hand the problem is not resolved, flow continues to decision element 644 where the customer can determine to receive more consultation with flow returning to block 638, or to try another solution (e.g., technician visit) with flow continuing to block 646.

With reference back to decision element 628, if the problem is one in which configurations and/or a settings change would resolve the problem, and the customer support representative is provided with authorization to change the setting, the representative can then change the settings, as indicated in block 630. As noted above, this change can be made by the representative by manipulating a virtual control panel or otherwise changing the information contained in the generated web pages. If the problem is resolved, as indicated in block 632, the communication link can be broken, as indicated in block 634, and flow is terminated.

Returning to decision element 626, if the customer support representative determines that a mere configuration and/or settings change will not resolve the problem, the representative, with the customer's assistance, can determine whether a technician visit is needed, as indicated in decision element 636. If so, flow continues to block 646 at which the communications link is terminated, and the customer support representative or customer can make arrangements for a service call in which a technician will visit the user's premises and resolve the problem.

While particular embodiments of the invention have been disclosed in detail in the foregoing description and drawings for purposes of example, it will be understood by those skilled in the art that variations and modifications thereof can be made without departing from the scope of the invention as set forth in the following claims.

What is claimed is:

1. A method for providing customer support to an electrical device user, comprising the steps of:
establishing a communications link between a customer support representative and the user with a customer support unit associated with the electrical device; and
transmitting communications of the customer support representative to the user while the user is at the electrical device via the customer support unit.

2. The method of claim 1, wherein the step of transmitting communications of the customer support representative comprises the step of transmitting audio and video data of the customer support representative to the customer support unit.

3. The method of claim 1, further comprising the step of transmitting communications of the user to the customer support representative via the customer support unit while the user is at the electrical device.

4. The method of claim 3, wherein the step of transmitting communications of the user comprises the step of transmitting audio and video data of the user to the customer support representative.

5. The method of claim 1, further comprising the step of presenting the customer support representative with information about the status and settings of the electrical device.

6. The method of claim 5, further comprising the step of permitting the customer support representative to change settings of the electrical device.

7. A system for providing customer support to an electrical device user, comprising:
means for transmitting customer support representative communications across a network; and
means for presenting the customer support representative communications to a user at the electrical device.

8. The system of claim 7, wherein the means for transmitting customer support representative communications comprises a microphone and video camera that are adapted to receive audio and video data of the customer support representative and wherein the means for presenting the customer support representative communications to the user comprises a speaker and a display that provide the user with audio and video data of the customer support representative.

9. The system of claim 8, wherein the means for transmitting customer support representative communications further comprises network interface devices.

10. The system of claim 7, further comprising means for transmitting user communications to the customer support representative.

11. The system of claim 10, wherein the means for transmitting user communications to the customer support representative comprises a microphone and video camera that are adapted to receive audio and video of the user.

12. The system of claim 7, further comprising means for presenting information regarding electrical device status and settings to the customer support representative.

13. The system of claim 12, wherein the means for presenting information regarding electrical device status and settings comprises a web server module.

14. The system of claim 7, further comprising means for allowing the customer support representative to change settings of the electrical device.

15. A system for providing customer support to a user of an electrical device, comprising:
a customer support unit that is adapted to electrically connect to the electrical device, the customer support unit comprising a speaker and a display that are adapted to present audio and video data of a customer support representative to the user; and
network interface devices that are adapted to transmit and receive communications across a network.

16. The system of claim 15, wherein the customer support unit further comprises a microphone and video camera that are adapted to capture audio and video data of the user.

17. The system of claim 15, wherein the network interface devices include a modem adapted for transmitting and receiving communications across the Internet.

18. The system of claim 15, further comprising a web server module adapted to generate web pages containing information about the status and settings of the electrical device.

19. The system of claim 15, further comprising a communications module that is adapted to facilitate communications between the system and a customer support representative.

20. A printer adapted for electrical connection with a peripheral device, comprising:
a speaker configured to present audio data of a customer support representative to a user;
a display configured to present video data of the customer support representative to a user;
a microphone configured to capture audio data of the user; and
a video camera configured to capture video data of the user.
